(19) United States
(12) Patent Application Publication
(10) Pub. No.: US 2011/0307278 A1
(43) Pub. Date: Dec. 15, 2011

(54) Managing insurance information using versioned and non-versioned data

(75) Inventors: Geoffrey Clarke, Foster City, CA (US); Stephen J. Bassett, San Francisco, CA (US); Michael Kuang-Chung Yang, Redwood City, CA (US); Alan Harrison Keefer, Belmont, CA (US)

(73) Assignee: Guidewire Software, Inc.

(21) Appl. No.: 12/802,589

(22) Filed: Jun. 9, 2010

(51) Int. Cl. G06Q 40/00

(52) U.S. Cl. 705/4

(57) ABSTRACT

Managing insurance information includes obtaining account information associated with an insurance account, selectively indicating a first portion of the account information that includes versioned information and a second portion of the account information that includes non-versioned information, obtaining policy information of an insurance policy associated with the insurance account, including copying at least some of the versioned information as a first portion of the insurance policy, and establishing a link between at least some of the non-versioned information and a second portion of the insurance policy. The second portion of the insurance policy that is linked with the non-versioned information is automatically updated to reflect changes to the non-versioned information.

### BACKGROUND OF THE INVENTION

An insurance policy holder often owns multiple insurance policies with the same insurer. For example, a person may own both an automobile policy on his vehicle and a home owner's policy on his residence; a business may own multiple commercial real estate policies on separate buildings. Existing insurance policy management systems typically generate separate policies, each containing its own set of information.

Certain information pertaining to the policy holder or the policies may change over time. Since separate sets of information for different policies are typically maintained by insurance policy management systems, the changed information often needs to be separately re-entered into the system for individual policies. For example, if the phone number of a person who owns both an automobile policy and a home owner's policy has been changed, current systems usually require the user (e.g., insurance agent) to re-enter the new number in both policies. Requiring the changed information to be re-entered multiple times requires extra administrative efforts and can be error-prone. Furthermore, tracking when the updated information should be incorporated into policies introduces additional complexity to the system. A better way to manage changes to insurance information is therefore needed.

### BRIEF DESCRIPTION OF THE DRAWINGS

Various embodiments of the invention are disclosed in the following detailed description and the accompanying drawings.

FIG. 1 is a functional diagram illustrating an embodiment of a programmed computer system for providing techniques for managing insurance information.

FIG. 2 is a data diagram illustrating the organization of insurance information according to some embodiments.

FIG. 3 is a flowchart illustrating an embodiment of a process for managing insurance information.

FIGS. 4A-4L are user interface diagrams illustrating an example in which the execution context determines the syncable status of certain fields.

FIGS. 5A-5K are user interface diagrams illustrating an example in which different roles determine which fields are versioned and which are non-versioned.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

Managing insurance information is disclosed. In some embodiments, certain information that can be shared across several policies is stored at the account level. The information is selectively set to be versioned or non-versioned. When policy information is obtained, non-versioned information is linked to the policy so that when there is change to the non-versioned information, the policy is automatically updated to reflect the change. Versioned information is copied from the account to the policy. When there is change to the versioned information, a stored version of the policy information is saved at the policy level and the part of the policy that corresponds to the versioned information is updated. In some embodiments, whether a piece of information is versioned or non-versioned depends on the context, such as which job is being executed or which role a contact is assigned.

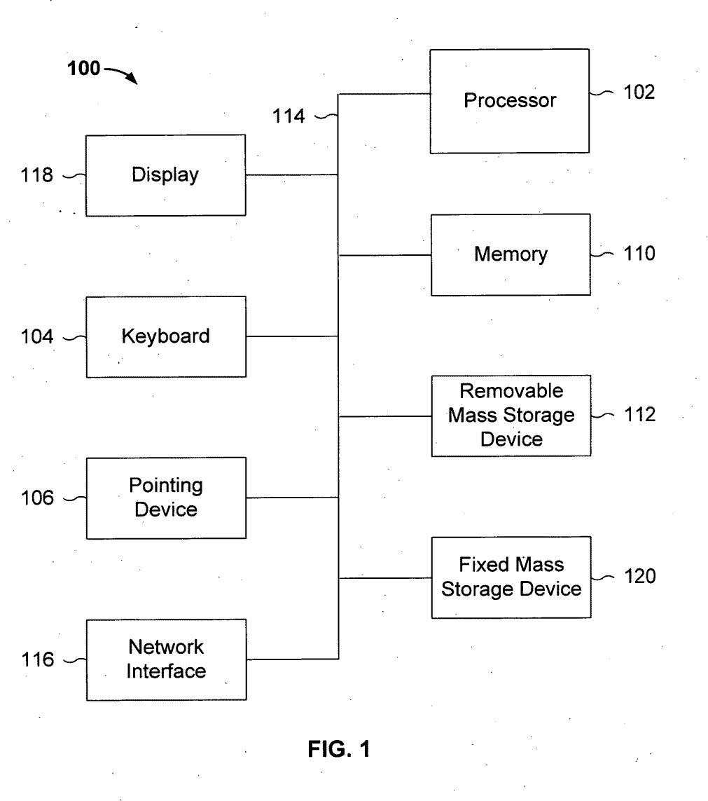

FIG. 1 is a functional diagram illustrating an embodiment of a programmed computer system for providing techniques for managing insurance information. As will be apparent, other computer system architectures and configurations can be used to perform techniques for managing insurance information. Computer system 100, which includes various subsystems as described below, includes at least one microprocessor subsystem (also referred to as a processor or a central processing unit, CPU) 102. For example, processor 102 can be implemented by a single-chip processor or by multiple processors. In some embodiments, processor 102 is a general purpose digital processor that controls the operation of the computer system 100. Using instructions retrieved from memory 110, the processor 102 controls the reception and manipulation of input data and the output and display of data on output devices (e.g., display 118). In some embodiments, processor 102, for example, in communication with a memory 110 (or other computer readable storage medium element(s)/device(s)), includes and/or is used to implement techniques for managing insurance information as described herein.

Processor 102 is coupled bidirectionally with memory 110, which can include a first primary storage, typically a random access memory (RAM), and a second primary storage area, typically a read-only memory (ROM). As is well known in the art, primary storage can be used as a general storage area, as scratch-pad memory, and can also be used to store input data and processed data. Primary storage can also store programming instructions and data, in the form of data objects and text objects, in addition to other data and instructions for processes operating on processor 102. Also as well known in the art, primary storage typically includes basic operating instructions, program code, data and objects used by the processor 102 to perform its functions (e.g., programmed instructions). For example, primary storage devices 110 can include any suitable computer-readable storage media, described below, depending on whether, for example, data access needs to be bidirectional or unidirectional. For example, processor 102 can also directly and very rapidly retrieve and store frequently needed data in a cache memory (not shown).

A removable mass storage device 112 provides additional data storage capacity for the computer system 100 and is coupled either bidirectionally (read/write) or unidirectionally (read only) to processor 102. For example, storage 112 can also include computer-readable media such as magnetic tape, flash memory, PC-CARDS, portable mass storage devices, holographic storage devices, and other storage devices. A fixed mass storage 120 can also, for example, provide additional data storage capacity. The most common example of mass storage 120 is a hard disk drive. Mass storage 112, 120 generally store additional programming instructions, data, and the like that typically are not in active use by the processor 102. It will be appreciated that the information retained within mass storage 112, 120 can be incorporated, if needed, in standard fashion as part of primary storage 110 (e.g., RAM) as virtual memory.

In addition to providing processor 102 access to storage subsystems, bus 114 can be used to provide access other subsystems and devices as well. As shown, these can include a display monitor 118, a network interface 116, a keyboard 104, and a pointing device 106 as well as an auxiliary input/output device interface, a sound card, speakers, and other subsystems as needed. For example, the pointing device 106 can be a mouse, stylus, trackball, or tablet and is useful for interacting with a graphical user interface.

The network interface 116 allows processor 102 to be coupled to another computer, computer network, or telecommunications network using a network connection as shown. For example, through the network interface 116, the processor 102 can receive information (e.g., data objects or program instructions) from another network or output information to another network in the course of performing method/process steps. Information, often represented as a sequence of instructions to be executed on a processor, can be received from and outputted to another network. An interface card or similar device and appropriate software implemented by (e.g., executed/performed on) processor 102 can be used to connect the computer system 100 to an external network and transfer data according to standard protocols. For example, various process embodiments disclosed herein can be executed on processor 102 or can be performed across a network, such as the Internet, intranet networks, or local area networks, in conjunction with a remote processor that shares a portion of the processing. Additional mass storage devices (not shown) can also be connected to processor 102 through network interface 116.

An auxiliary I/O device interface (not shown) can be used in conjunction with computer system 100. The auxiliary I/O device interface can include general and customized interfaces that allow the processor 102 to send and, more typically, receive data from other devices such as microphones, touch-sensitive displays, transducer card readers, tape readers, voice or handwriting recognizers, biometrics readers, cameras, portable mass storage devices, and other computers.

In addition, various embodiments disclosed herein further relate to computer storage products with a computer readable medium that includes program code for performing various computer-implemented operations. A computer-readable medium is any data storage device that can store data which can thereafter be read by a computer system. Examples of computer-readable media include, but are not limited to, all the media mentioned above: magnetic media such as hard disks, floppy disks, and magnetic tape, optical media such as CD-ROM disks, magneto-optical media such as optical disks, and specially configured hardware devices such as application-specific integrated circuits (ASICs), programmable logic devices (PLDs), and ROM and RAM devices. Examples of program code include both machine code, as produced, for example, by a compiler or files containing higher level code (e.g., script) that can be executed using an interpreter.

The computer system shown in FIG. 1 is but an example of a computer system suitable for use with the various embodiments disclosed herein. Other computer systems suitable for such use can include additional or fewer subsystems. In addition, bus 114 is illustrative of any interconnection scheme serving to link the subsystems. Other computer architectures having different configurations of subsystems can also be utilized.

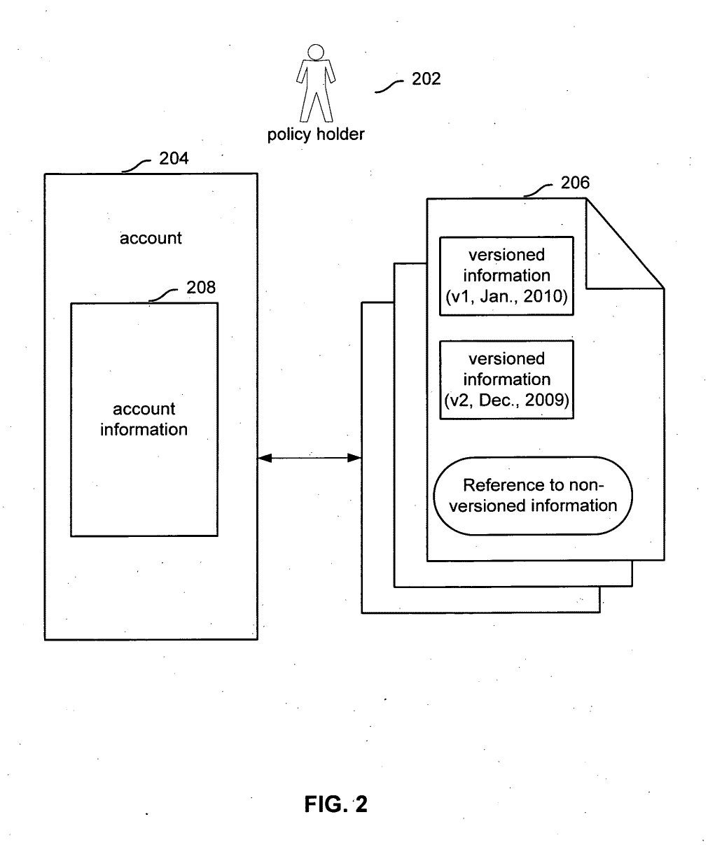

FIG. 2 is a data diagram illustrating the organization of insurance information according to some embodiments. In the example shown, an insurance policy holder 202 has an insurance account 204 on the insurer's management system and owns multiple insurance policies 206. At the account level, multiple fields are obtained and the information pertaining to the account is collectively referred to as account information. Some account information is shared across policies. Such information is sometimes referred to as syncable account information. Examples of syncable account information include contact information for the named insured, location information of the item or activity to be insured, policy address information of the insured, etc. The account information is saved in a data store.

At the policy level, multiple values corresponding to various policy fields are obtained for each policy. As discussed above, some policy information is associated with corresponding account information and the policy information and the account information is synchronized as appropriate. In particular, some policy information whose historical values are of interest, such as information affecting the terms of the policy contract, is copied from an account level data store to a policy level data store. Examples of such information include the name of the insured and location of the item or activity being insured. Such information is referred to as versioned information since multiple versions of the information are stored. In various embodiments, versioned information may be saved at specific points in time, when the policy is modified, or at any other time deemed appropriate. In the discussion below, examples are given for saving the new version at the policy level, although in other embodiments the new version can be saved elsewhere depending on implementation. In some embodiments, a new version is saved when the policy is bound and a new contract based on the policy is formed between the insurance company and the policy holder. Older versions are also maintained so that it is possible to reconstruct the particular version of the policy contract in effect at a specific point in time.

Some other policy information that does not affect the terms of the policy contract, such as telephone number of the insured, is linked with the corresponding information at the account level using a reference, a handle, a pointer, or the like. Such information is referred to as non-versioned information since the up-to-date information is saved at the account level while past information is not needed.

As will be described in greater detail below, the same piece of information may be deemed versioned or non-versioned depending on context.

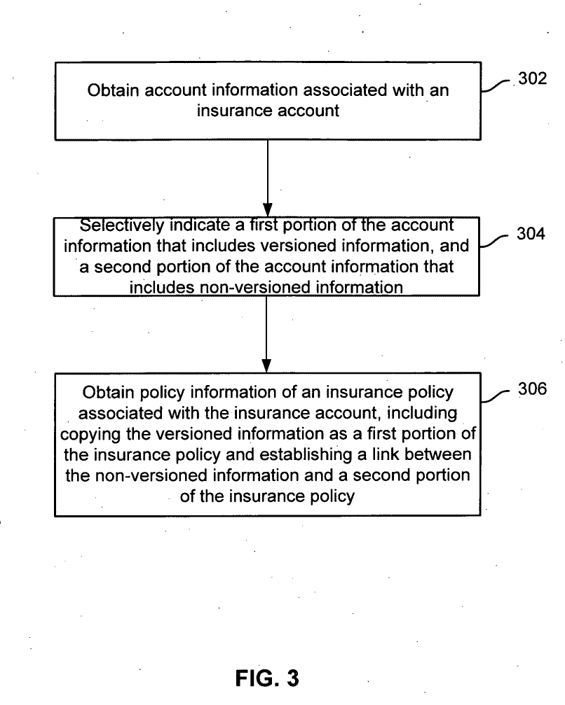

FIG. 3 is a flowchart illustrating an embodiment of a process for managing insurance information. The process may be implemented on a system such as 100. At 302, account information associated with an insurance account is obtained. In various embodiments, the account information is obtained by configuration by a user such as an insurance company underwriter or agent, by reading from a stored location, or by any other appropriate means. In some embodiments, a policy modification may trigger an update of account information and cause account information to be obtained. In some embodiments, the information is obtained and then stored at a memory or storage location associated with the account.

At 304, a first portion of the account information that includes versioned information and a second portion of the account information that includes non-versioned information are selectively indicated. In some embodiments, obtaining account information by configuration involves configuring an entity such as a contact object with multiple fields such as address, name, phone number, etc. Each field may be set as a versioned or a non-versioned field by default or by configuration carried out by the system administrator during system setup. In some embodiments, the syncable status of a field (i.e., whether it is versioned or non-versioned) is indicated using metadata associated with the field or the entity. As will be described in greater detail below, in some embodiments, whether a field is versioned or non-versioned can change depending on context, such as job context or role context.

At 306, policy information of an insurance policy associated with the insurance account is obtained. The policy information may be obtained by configuration by a user such as an insurance company underwriter or agent, reading from a stored location, or any other appropriate means. In some embodiments, modifications to the account information can also trigger an update of the policy information. When the policy is ready to be bound, some of the versioned information is copied to the corresponding fields in the insurance policy, forming a current version of the insurance information. In addition, a link between some of the non-versioned information and a second portion of the insurance policy is established, such that the second portion of the insurance policy that is linked with the non-versioned information is automatically updated to reflect changes to the non-versioned information. Since the link serves as a reference or pointer, non-versioned information of the account does not have to be saved at the policy level.

In some embodiments, the syncable status is context-dependent. In other words, the same piece of information may be versioned in one context, but non-versioned in a different context. An example of a context that can affect the syncable status is the execution context, i.e., the type of job that is being executed. In some embodiments, different types of jobs are associated with different rules of how to process certain fields. For example, if the current job is creating a new policy, then all the fields reference their current version and the most recent information is obtained. If the current job involves reviewing an existing policy, then the fields affecting the policy contract are versioned and the values corresponding to the policy under review are retrieved and displayed.

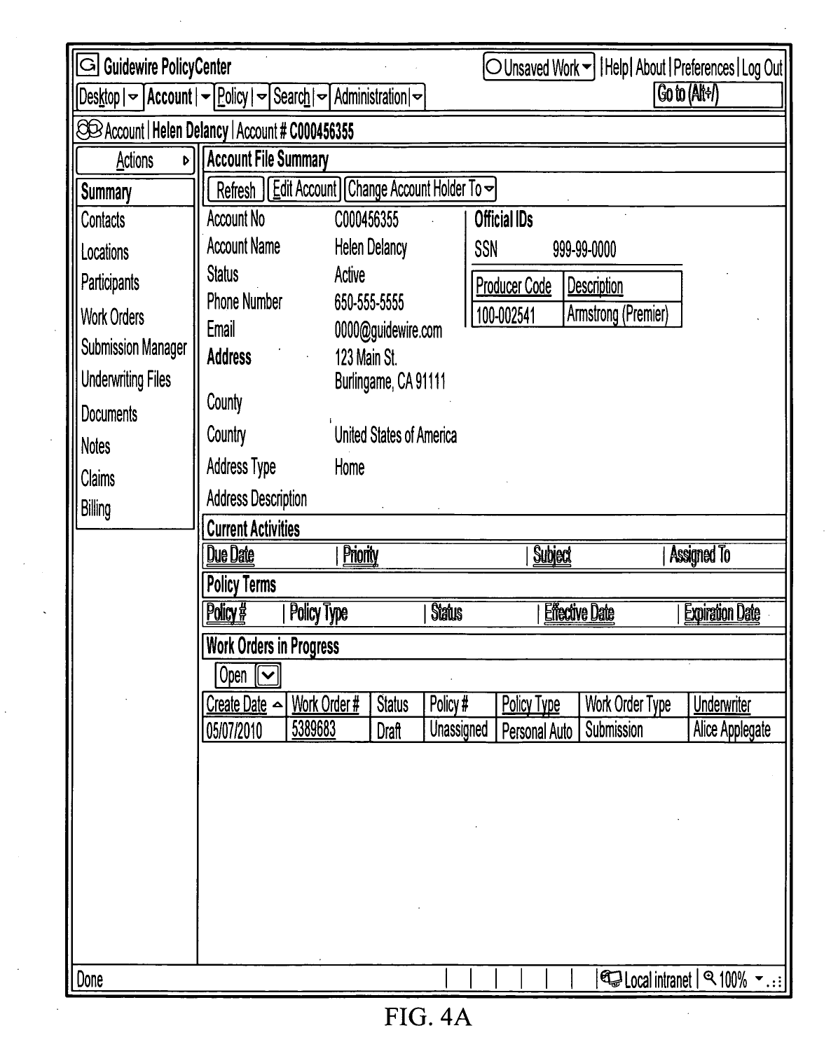

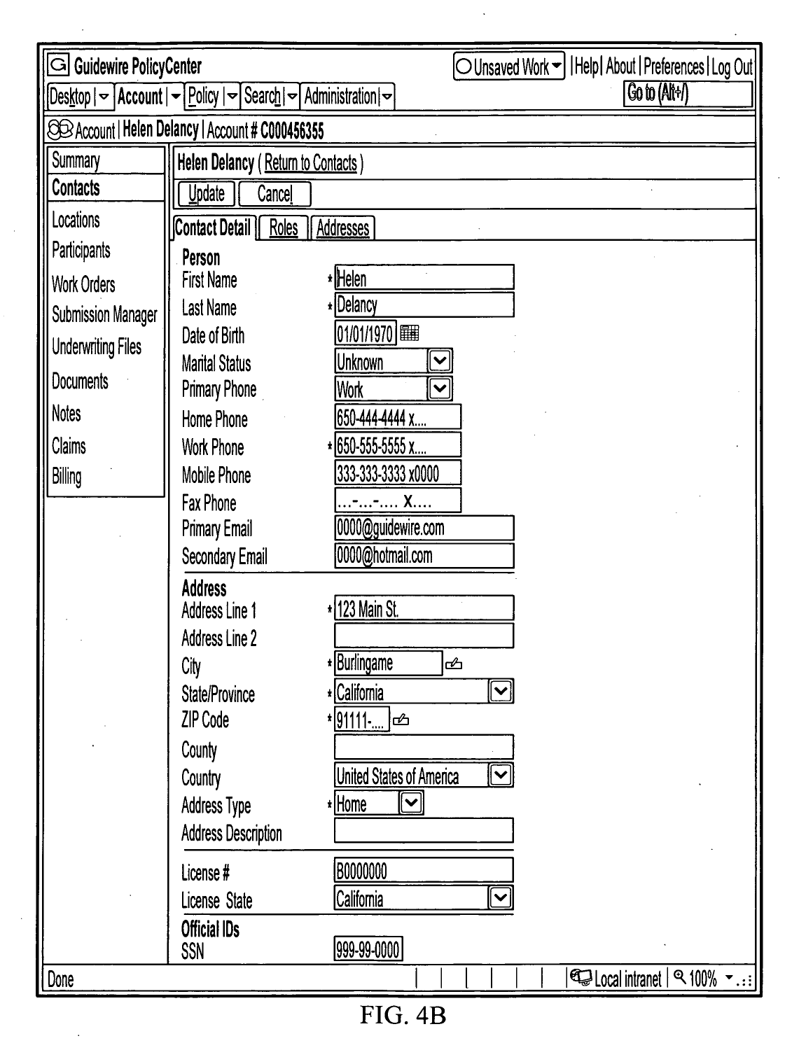

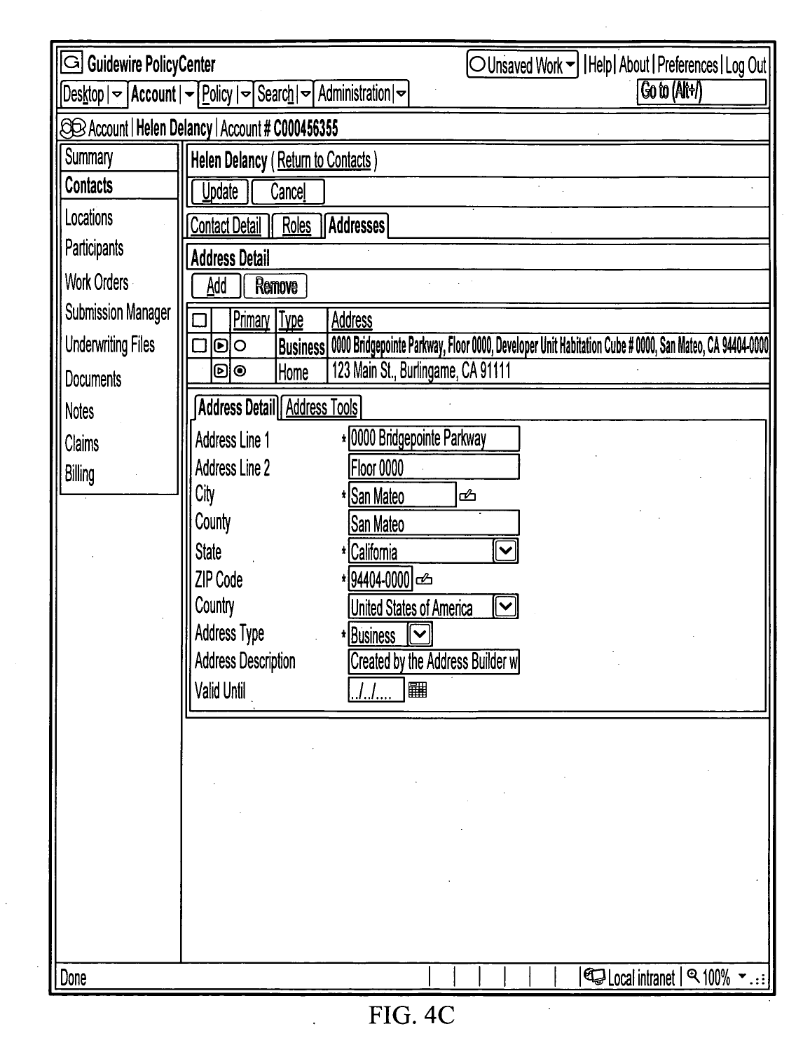

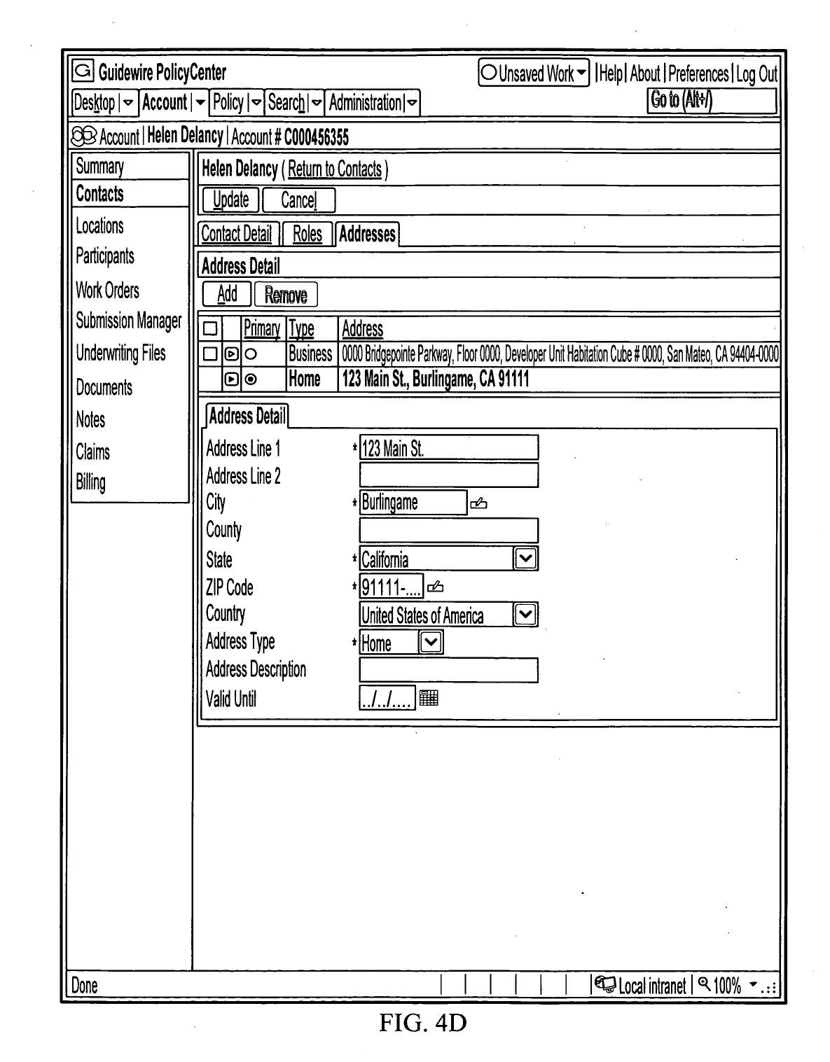

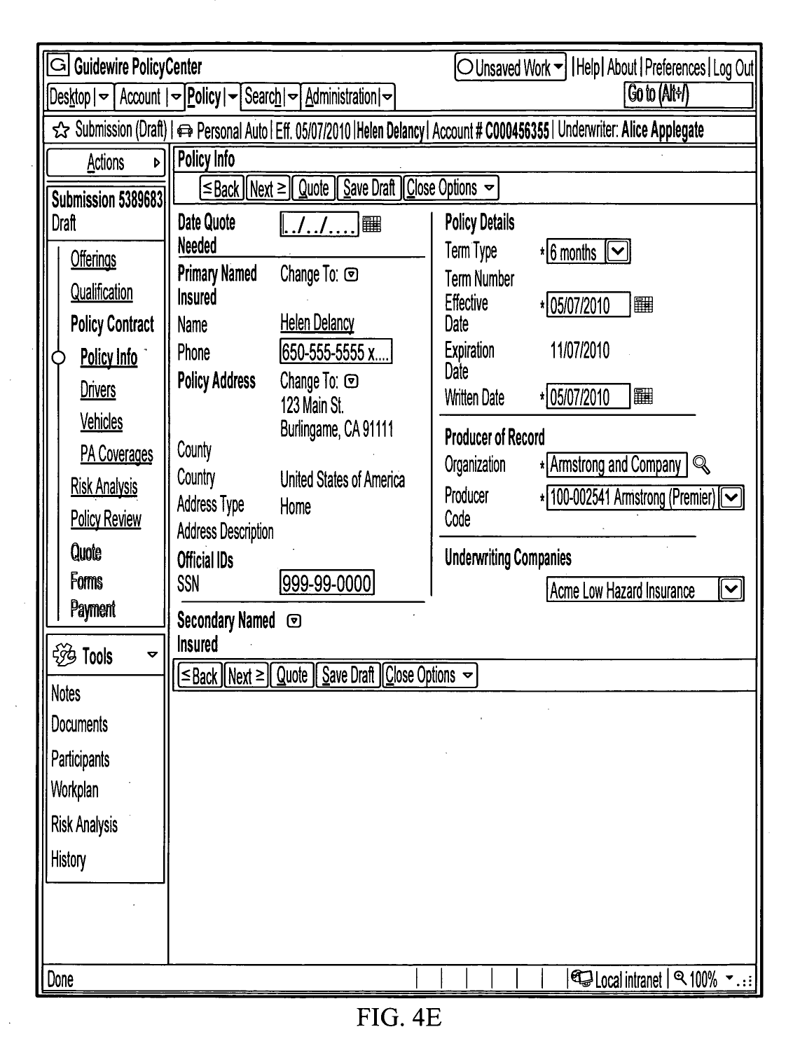

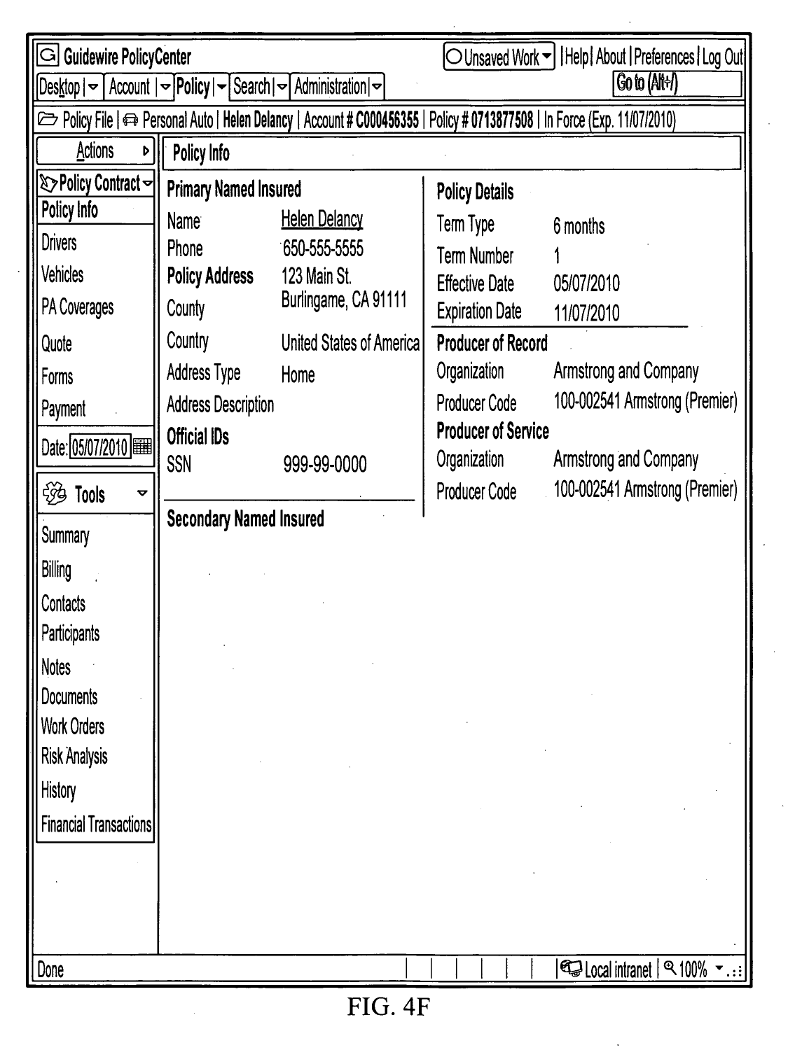

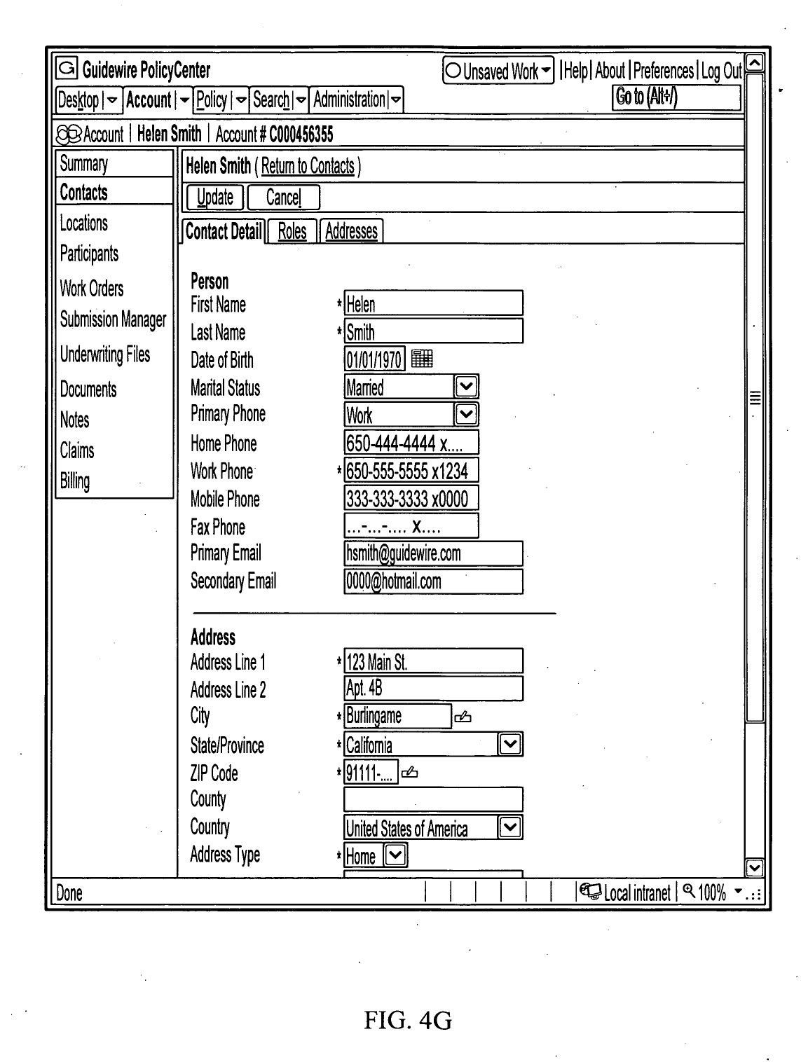

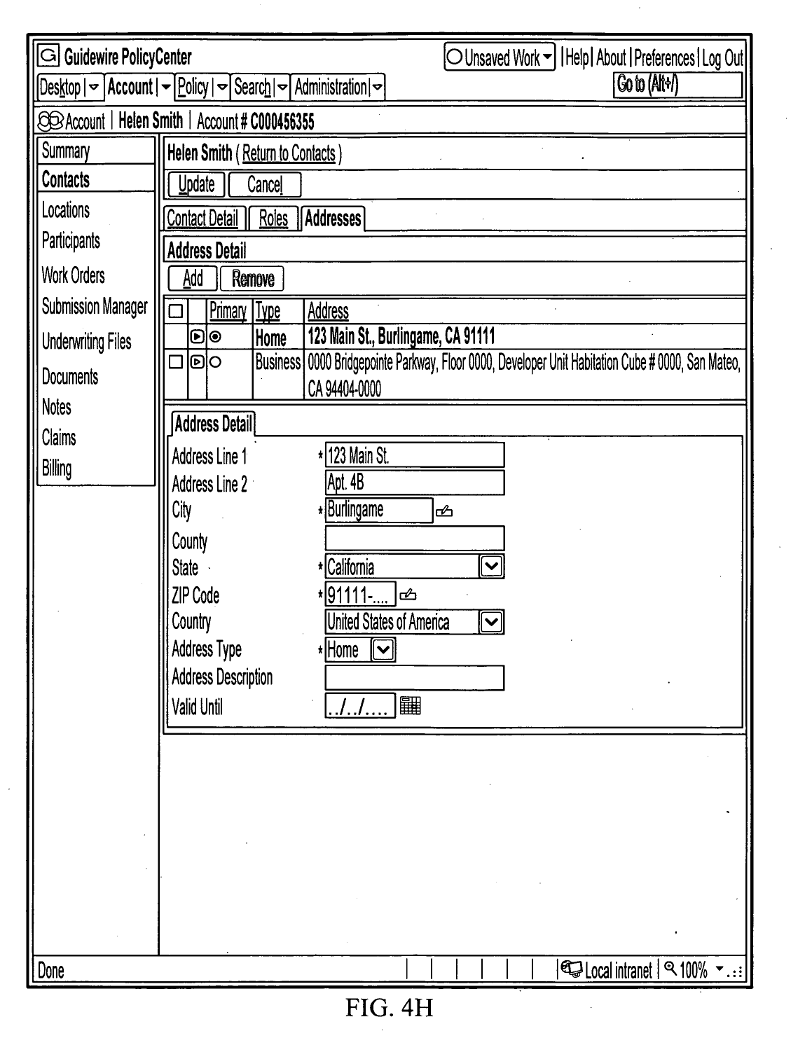

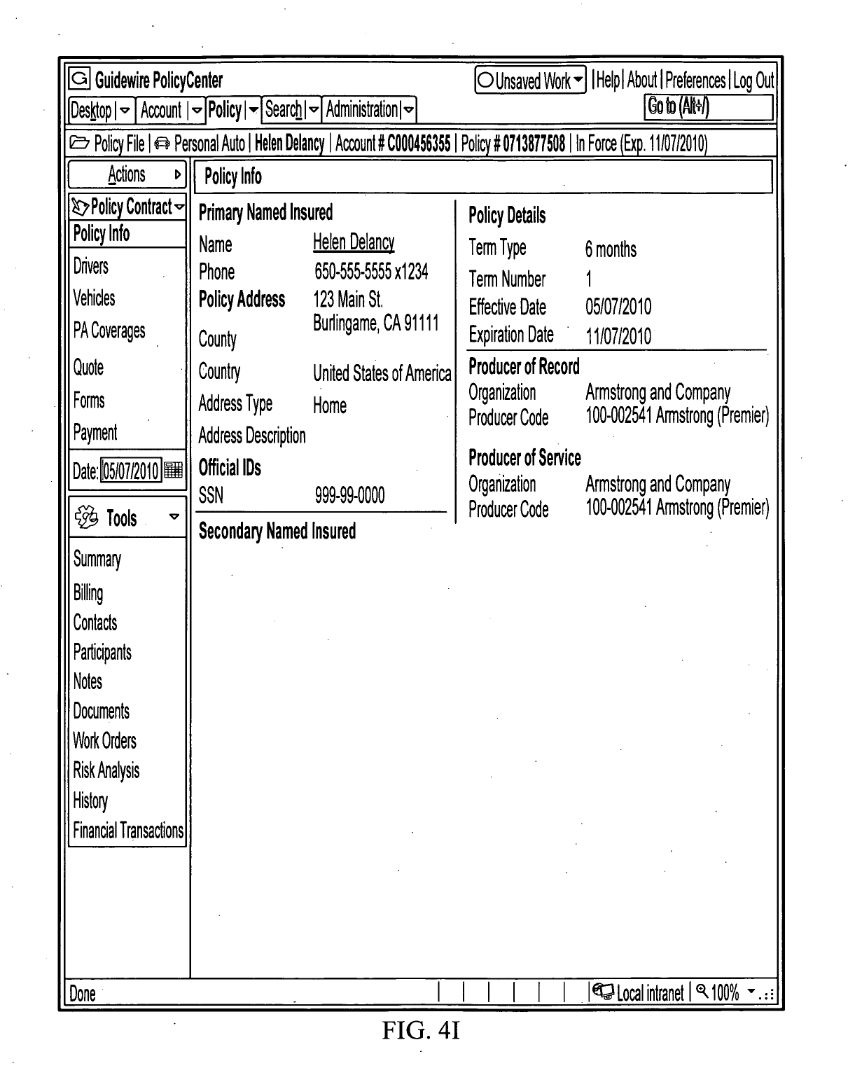

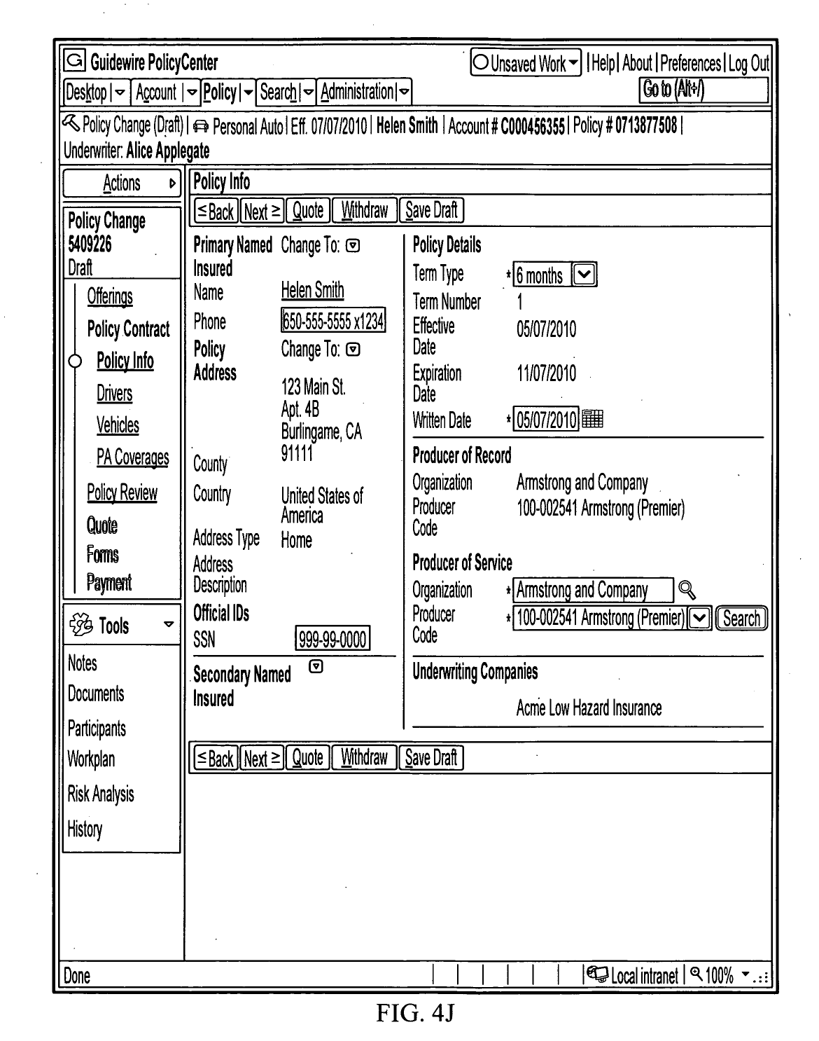

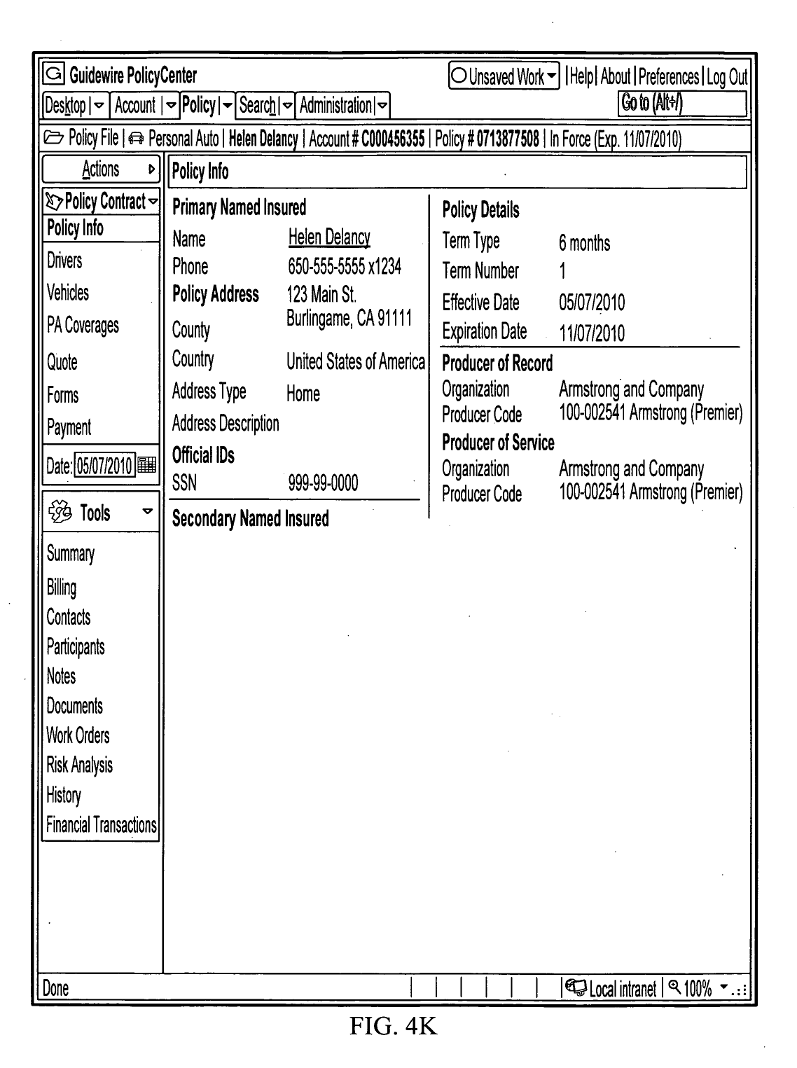

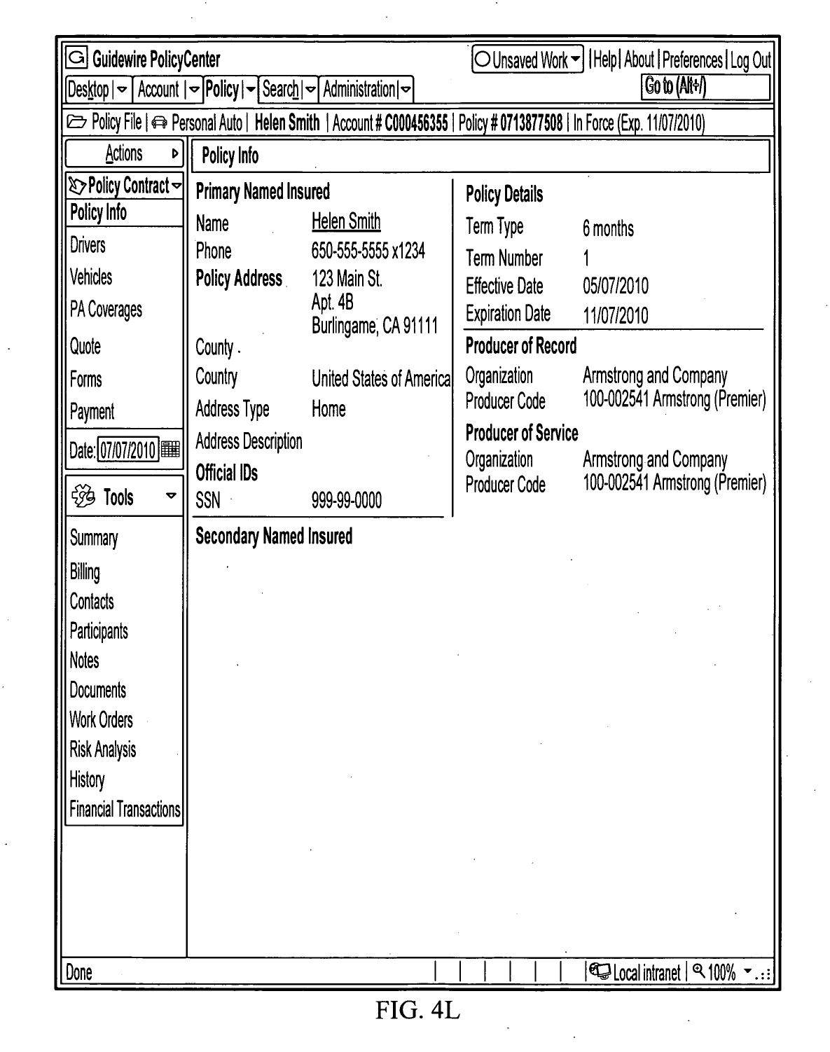

In some embodiments, the execution context is determined programmatically or by user invocation of a job execution user interface. FIGS. 4A-4L are user interface diagrams illustrating an example in which the execution context determines the syncable status of certain fields.

As shown in FIG. 4A, in May 2010 an account is initialized for account holder Helen Delancy. In FIG. 4B, Helen's contact information is configured. FIG. 4C and FIG. 4D illustrate the configurations of Helen's business address and home address, respectively. In FIG. 4E, a new job for generating a new personal automobile policy is submitted. Here, Helen's home address is used as the default primary address for the policy. The policy is bound and issued. Thus, in FIG. 4F, where the policy information is being reviewed, the information that has just been submitted is returned.

In July 2010 Helen calls the insurance company and provides some updated information. Helen has gotten married and her legal name is changed to Helen Smith; there is an extension that is added to her primary phone number (which is the work phone number in this case); her email address has changed; and there is an apartment number that has been added to her home address. An insurance company representative modifies the changed information at the account level as shown in FIGS. 4G and 4H.

FIG. 4I shows a view of the bound policy. In the context of executing the job of reviewing the current policy, information of the latest policy is displayed. Since the name of the insured and the policy address are part of the contract that was formed, these fields are versioned and the last version of the information saved after the policy was bound is selected and displayed instead of the updated information. The work telephone number is not a part of the legal contract and therefore is non-versioned. A link is established between the work telephone number of the policy and that of the account for displaying the most up-to-date phone number stored on the account level.

FIG. 4J shows the policy information while making a policy change. In this job context, a new policy contract will be formed based on the most recent information. Thus, the most recent information is retrieved and displayed for all the fields. A new policy is bound with the most recent information and the new policy is issued.

In the context of displaying a specific version of the policy, information affecting the terms of to the contract is versioned and the corresponding version is displayed. Other information not pertaining to the contract is non-versioned. FIG. 4K shows the policy information as of May 7, 2010. Helen's name and address are versioned and their previous versions are displayed. Her phone number is not versioned and the most recent phone number is displayed. FIG. 4L shows the policy information as of Jul. 7, 2010. This policy, which has captured all the updated information, displays the most recent versions of Helen's name and address, as well as the most recent phone number.

In some embodiments, the system administrator is given the option to configure the behavior triggered by changes to certain information, as well as the timing of the behavior. For example, the system administrator may wish to configure an automatically generated policy change job as soon as certain information changes since such changes can sometimes affect the pricing of the policy and consequently the coverage provided. For example, when the address of the named insured changes, the policy premium is likely to change based on the new location. The system may be configured in such a way that the insurance representative is notified of the change and given the option to start a policy change job whenever versioned information is modified. Alternatively, the system may be configured so that a policy change takes place automatically. A new quote is generated, and if the account holder accepts the new quote, a new policy is bound and issued. As another example, the system administrator may wish to delay any policy changes when certain other information changes. For example, moving violations can increase policy premiums when the policy is renewed. If a driver receives a moving violation, the information is stored at the account level and linked to the policy, but the policy does not change until it is ready to be renewed.

Another example of a context is the type of role of a contact. A contact in an insurance policy may take on various roles such as the insured (e.g., the driver), a party of interest (e.g., the insured/policy holder), etc. In some embodiments, a field associated with a contact, such as driver license number and state, is deemed to be versioned or non-versioned depending on the role of the contact. If the contact takes on the role of a driver, then the license information is a part of the contract formed by the policy, and the historic values of the license number and state are of interest and the fields are versioned in this context. If, however, the contact takes on the role of the policy holder, it is used for identification purposes only and does not affect the policy contract. The license information is therefore non-versioned in this context.

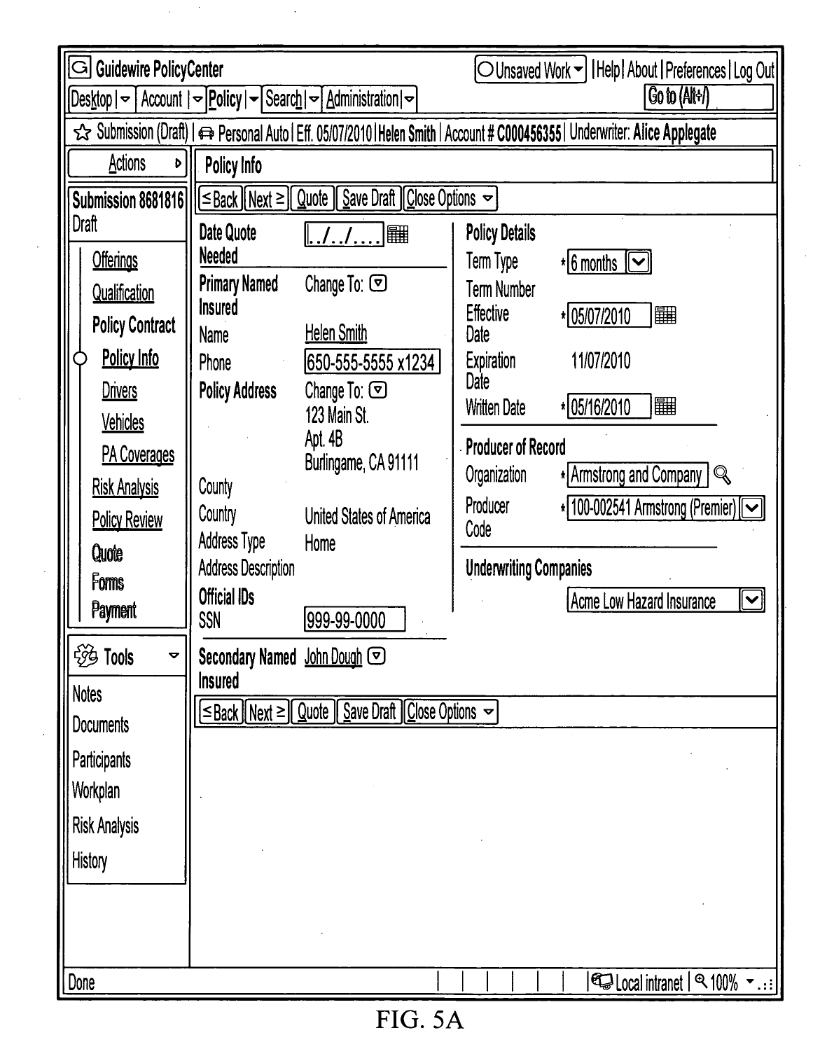

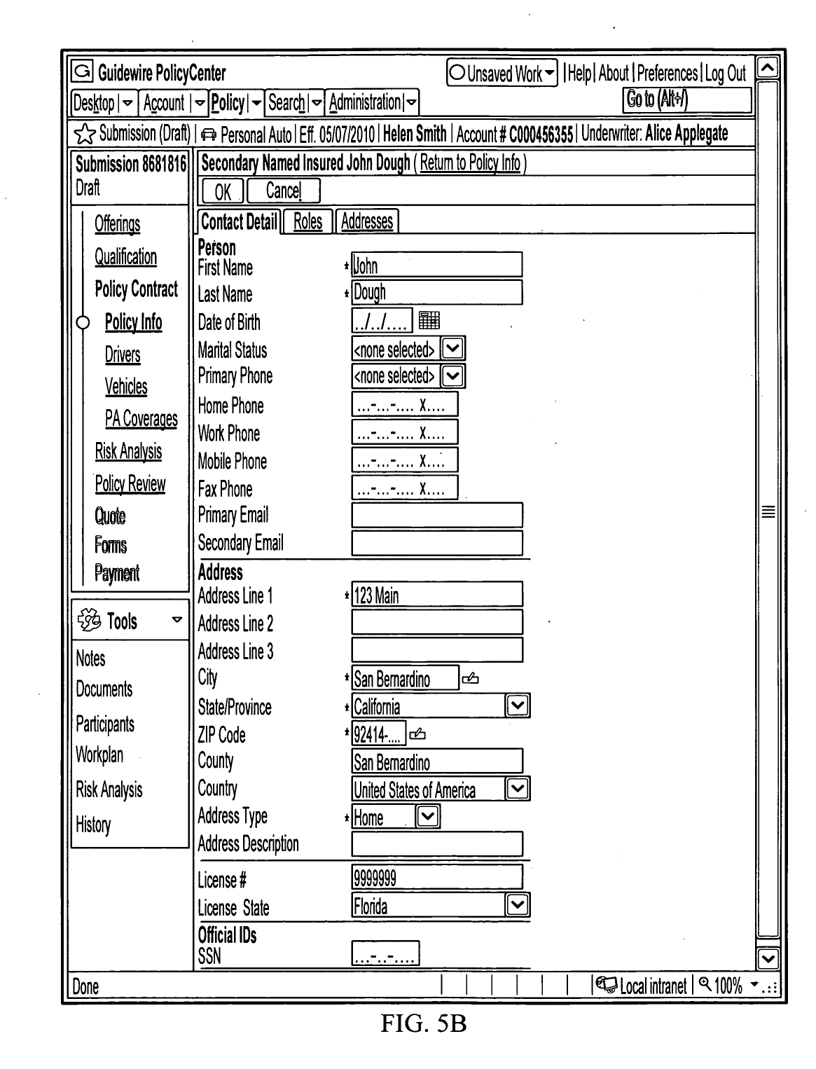

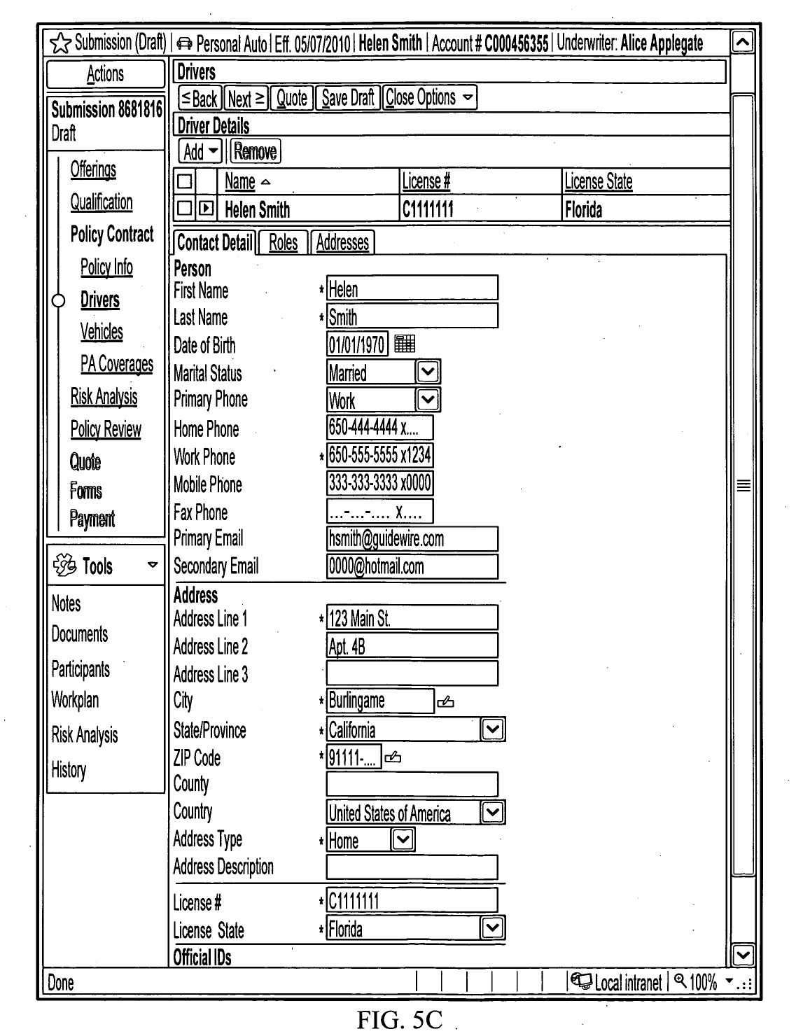

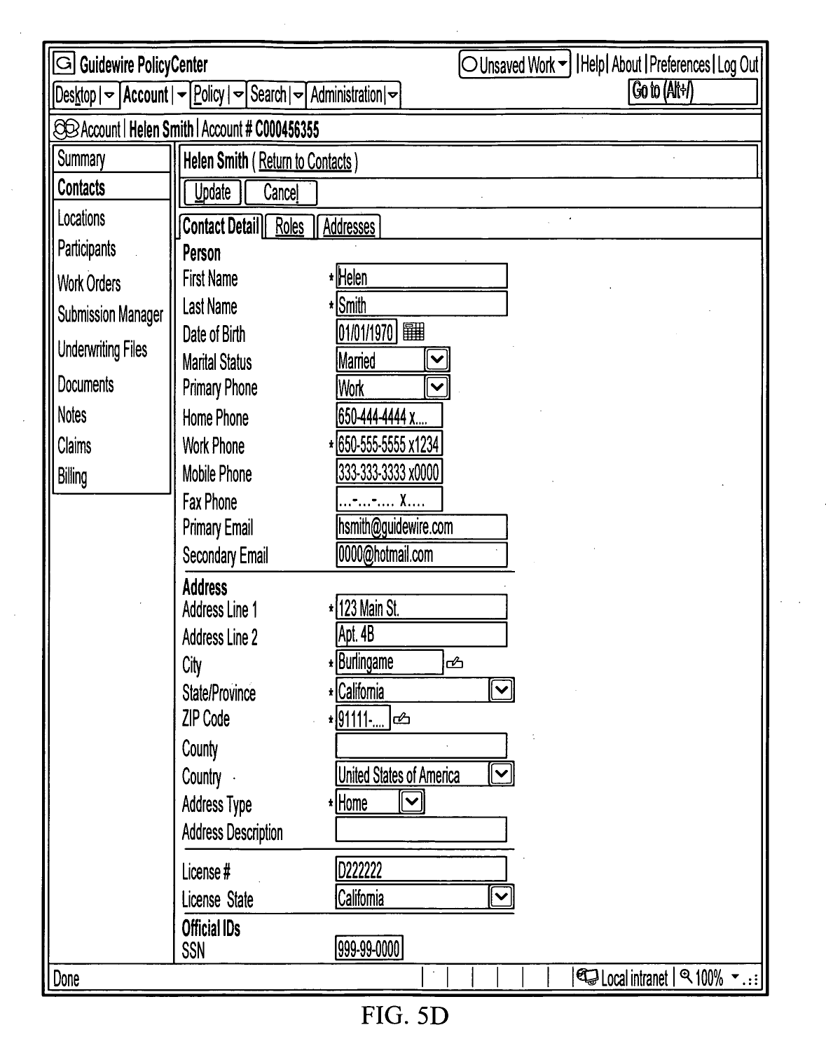

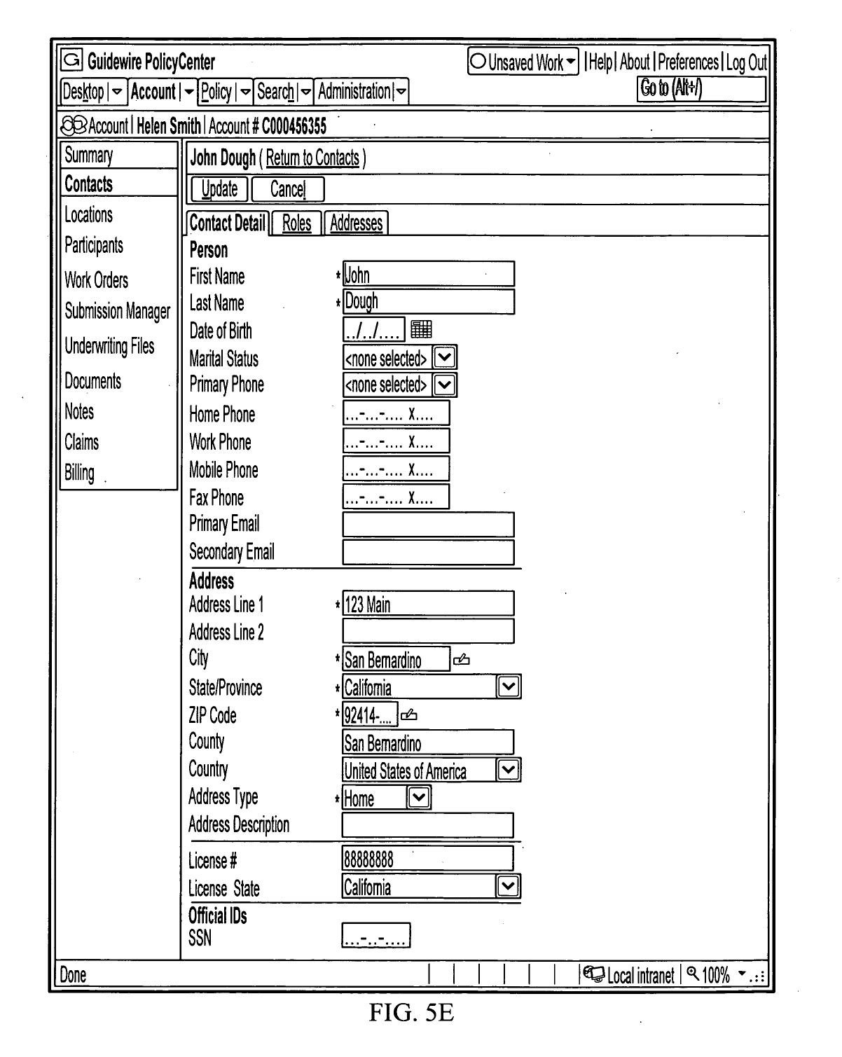

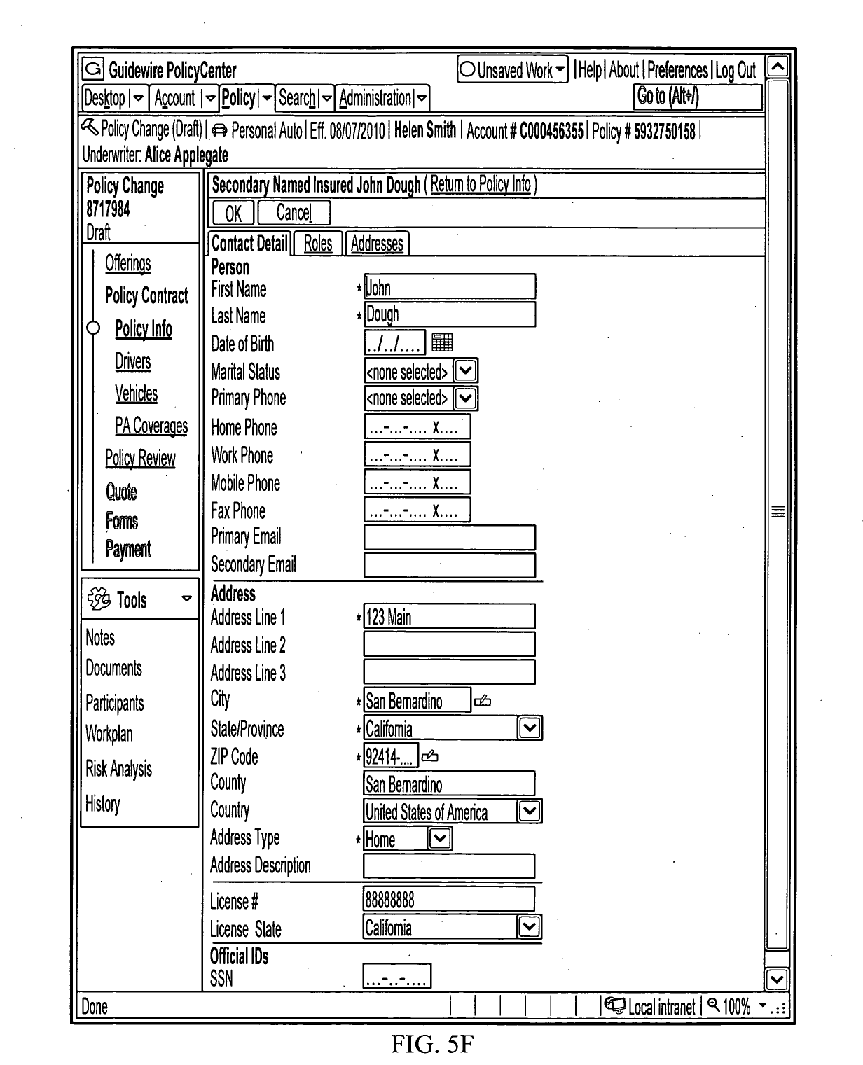

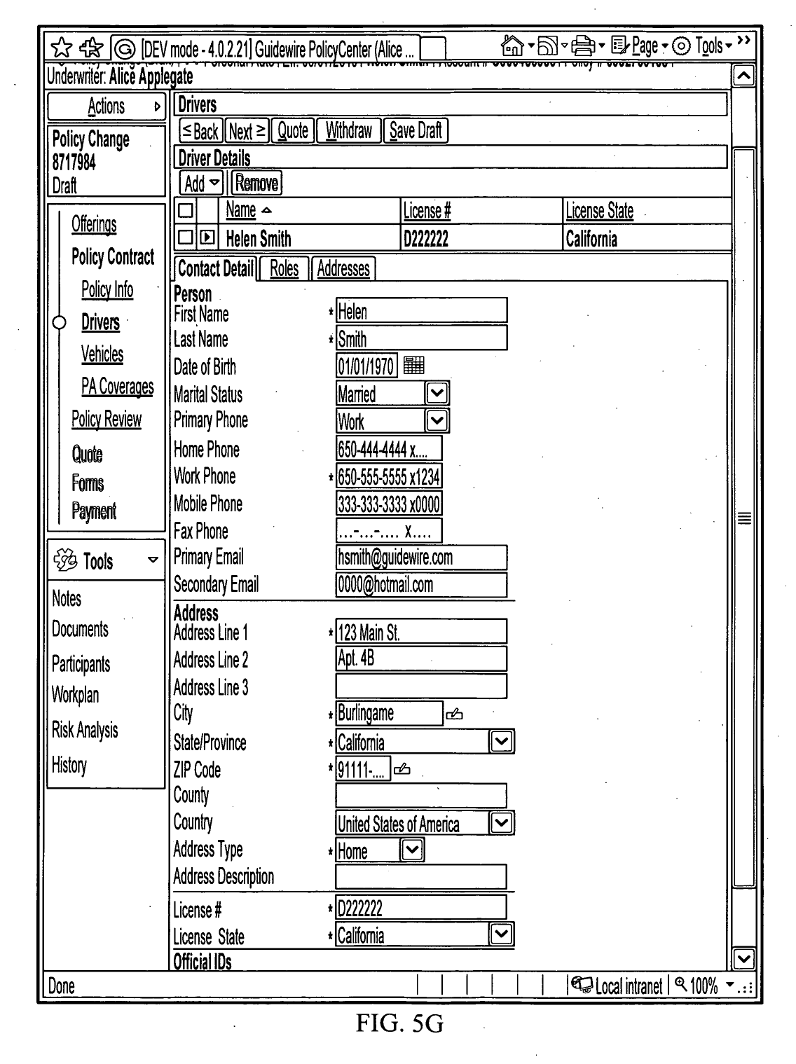

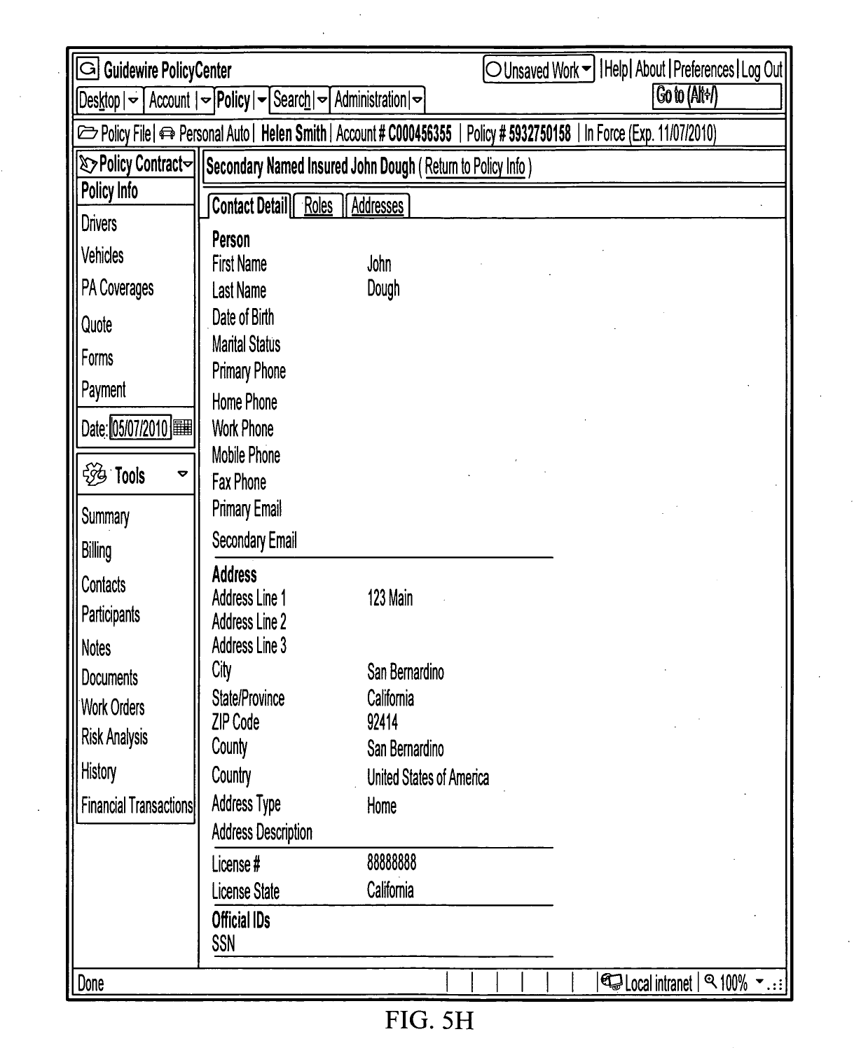

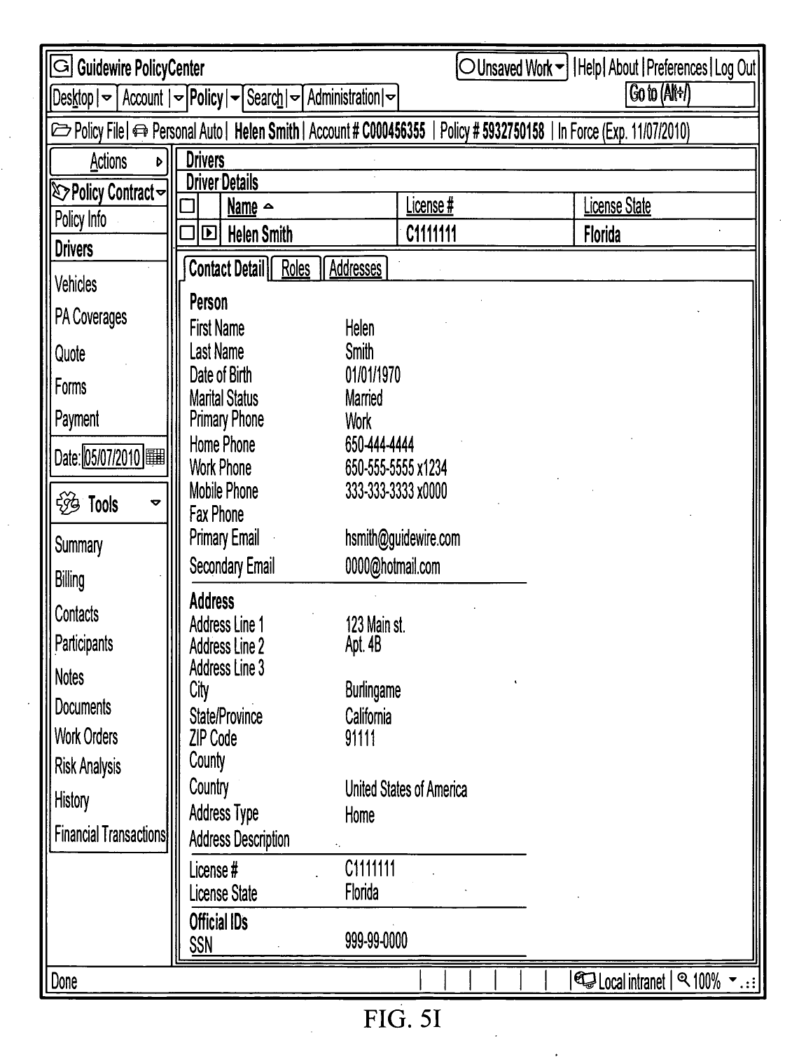

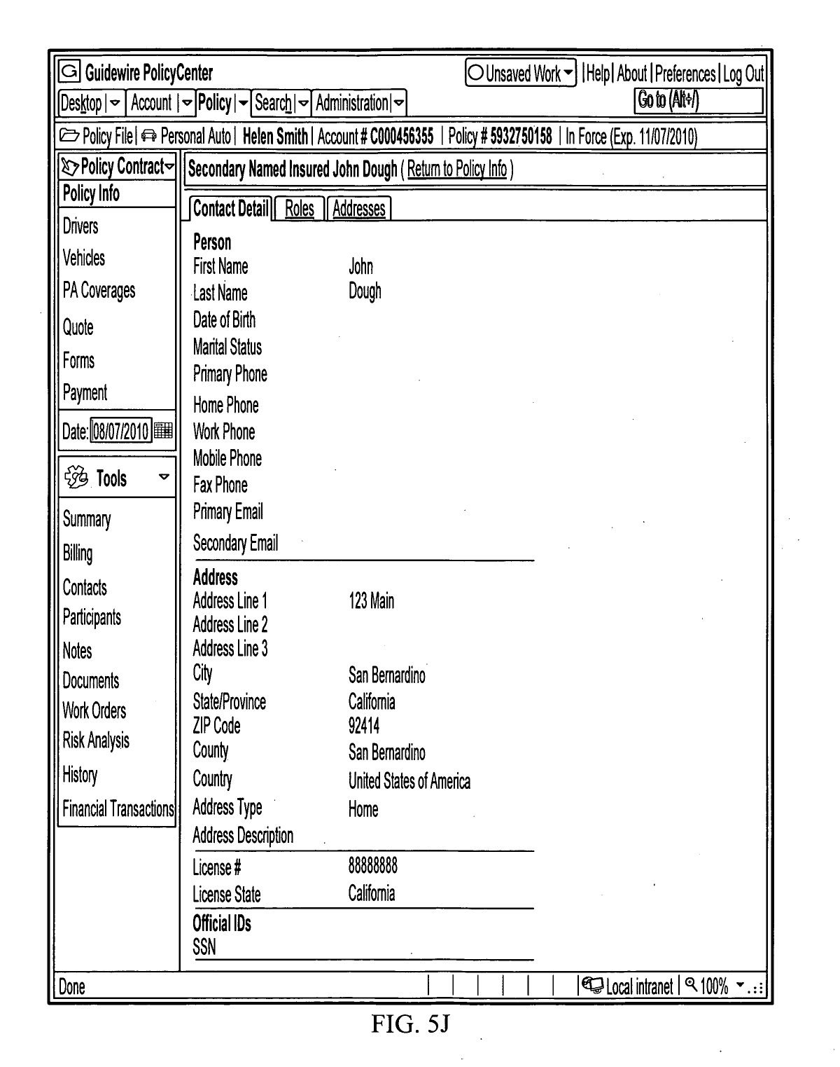

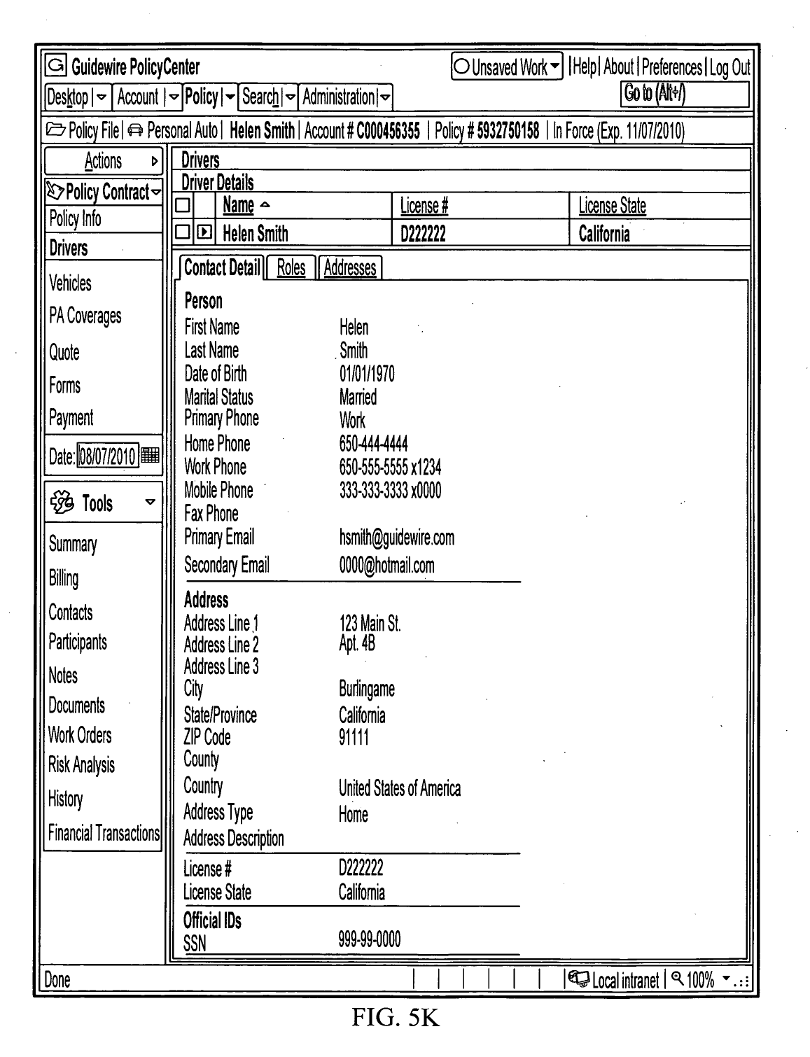

FIGS. 5A-5K are user interface diagrams illustrating an example in which different roles determine which fields are versioned and which are non-versioned.

FIG. 5A shows the policy configuration interface. Effective May 7, 2010 Helen Smith is configured as the primary named insured of a personal auto policy and John Dough is configured as the secondary named insured. Their contact information is saved to the account level.

FIG. 5B shows John Dough's information at the time the policy information is submitted and bound. Presently, John Dough has a Florida's driver's license with the number of 9999999.

FIG. 5C shows the interface for adding drivers to the policy. Here, Helen Smith takes on a new role as a driver. Her Florida driver's license number is C1111111. John Dough, however, is not going to be a driver for this car and is not added as a driver.

Later, Helen and John both get California driver's licenses. Their information is updated at the account level. FIGS. 5D-5E show the account information for Helen and John. Helen's new license number is California #D222222 and John's is California #8888888.

A policy change then takes place on Aug. 7, 2010. John's and Helen's current driver's license information is stored and displayed in FIGS. 5F and 5G, respectively. The policy change is bound, effective Aug. 7, 2010.

FIG. 5H shows the policy information as of May 7, 2010, the date of the original bound policy contract. Specifically, the contact information of John Dough is displayed. In the context of his role as a named insured, John's driver's license number is for identification purposes only and is not a part of the policy contract. Thus, the driver's license field is non-versioned and the most up-to-date information for John's California driver's license is displayed.

FIG. 5I is another display of the policy information as of May 7, 2010. Specifically, the driver information of Helen is displayed. In the context of her role as a driver, Helen's driver's license information is a part of the policy contract. Thus, the field is versioned and the original version, i.e., the Florida driver's license information, is displayed.

FIGS. 5J and 5K show the policy information as of Aug. 7, 2010. As shown in FIG. 5J, in the context of his role as a secondary named insured, John Dough's most current driver's license information continues to be displayed. As shown in FIG. 5K, in the context of the role of a driver, the version of the license information that corresponds to the Aug. 7, 2010 policy, i.e., the California driver's license information for Helen, is displayed.

In some embodiments, the configurations of different roles and the syncable status of their respective fields are predetermined by default settings. In some embodiments, the system administrator is given the option to modify the settings.

Managing insurance information by using versioned and non-versioned information has been disclosed. By allowing information to be set as versioned or non-versioned at account level, duplicative data entry is eliminated, and greater flexibility in the use and display of information is achieved.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A method for managing insurance information, comprising:
obtaining account information associated with an insurance account;
selectively indicating a first portion of the account information that includes versioned information and a second portion of the account information that includes non-versioned information; and
obtaining policy information of an insurance policy associated with the insurance account, including copying at least some of the versioned'information as a first portion of the insurance policy and establishing a link between at least some of the non-versioned information and a second portion of the insurance policy; wherein:
the second portion of the insurance policy that is linked with the non-versioned information is automatically updated to reflect changes to the non-versioned information.

2. The method of claim 1, further comprising saving a stored version of the first portion of the insurance policy and updating the first portion of the insurance policy to correspond to a modified versioned information.

3. The method of claim 1, further comprising saving a stored version of the first portion of the insurance policy and updating the first portion of the insurance policy to correspond to a modified versioned information of a bound insurance policy.

4. The method of claim 1, wherein obtaining the account information includes configuring an entity that includes versioned information and non-versioned information.

5. The method of claim 4, wherein the entity includes contact information.

6. The method of claim 4, wherein the entity includes location information.

7. The method of claim 4, wherein the entity includes address information.

8. The method of claim 1, wherein the first portion of the account information is a first configurable field and the second portion of the account information is a second configurable field.

9. The method of claim 1, wherein configuring the account includes configuring a contact; and
the method further comprises specifying a role associated with the contact, said role determining whether information pertaining to the contact is versioned information or non-versioned information.

10. The method of claim 1, further comprising executing a job associated with the policy, wherein the first portion of the insurance policy and the second portion of the insurance policy are determined by a job type of the job.

11. The method of claim 3, further comprising generating a policy change job when the versioned information changes.

12. The method of claim 1, wherein the versioned information comprises information that affects a contract specified by the policy.

13. The method of claim 1, wherein selectively indicating a first portion of the account information that includes versioned information and a second portion of the account information that includes non-versioned information comprises providing metadata information that identifies data fields as either versioned or non-versioned.

14. The method of claim 1, wherein automatically updating the second portion comprises, when the policy is accessed, querying the account information to provide updated non-versioned information.

15. A system for managing insurance information, comprising:
a processor configured to:
obtain account information associated with an insurance account;
selectively indicate a first portion of the account information that includes versioned information and a second portion of the account information that includes non-versioned information; and
obtain policy information of an insurance policy associated with, the insurance account, including copying at least some of the versioned information as a first portion of the insurance policy and establishing a link between at least some of the non-versioned information and a second portion of the insurance policy; wherein:
the second portion of the insurance policy that is linked with the non-versioned information is automatically updated to reflect changes to the non-versioned information; and
a memory coupled to the processor and configured to provide the processor with instructions.

16. The system of claim 15, the processor is further configured to save a stored version of the first portion of the insurance policy and update the first portion of the insurance policy to correspond to a modified versioned information.

17. The system of claim 15, wherein the processor is further configured save a stored version of the first portion of the insurance policy and update the first portion of the insurance policy to correspond to a modified versioned information of a bound insurance policy.

18. The system of claim 15, wherein obtaining the account information includes configuring an entity that includes versioned information and non-versioned information.

19. The system of claim 15, wherein the first portion of the account information is a first configurable field and the second portion of the account information is a second configurable field.

20. The system of claim 15, wherein configuring the account includes configuring a contact; and the processor is further configured to specify a role associated with the contact, said role determining whether information pertaining to the contact is versioned information or non-versioned information.

21. The system of claim 15, wherein the processor is further configured to execute a job associated with the policy, wherein the first portion of the insurance policy and the second portion of the insurance policy are determined by a job type of the job.

22. The system of claim 17, wherein the processor is further configured to generate a policy change job when the versioned information changes.

23. The system of claim 15, wherein the versioned information comprises information that affects a contract specified by the insurance policy.

24. The system of claim 15, wherein selectively indicating a first portion of the account information that includes versioned information and a second portion of the account information that includes non-versioned information comprises providing metadata information that identifies data fields as either versioned or non-versioned.

25. A computer program product for managing insurance information, the computer program product being embodied in a computer readable storage medium and comprising computer instructions for:
obtaining account information associated with an insurance account;
selectively indicating a first portion of the account information that includes versioned information and a second portion of the account information that includes non-versioned information; and
obtaining policy information of an insurance policy associated with the insurance account, including copying at least some of the versioned information as a first portion of the insurance policy and establishing a link between at least some of the non-versioned information and a second portion of the insurance policy; wherein:
the second portion of the insurance policy that is linked with the non-versioned information is automatically updated to reflect changes to the non-versioned information.
